(19) United States
(12) Patent Application Publication
(10) Pub. No.: US 2011/0111958 A1
(43) Pub. Date: May 12, 2011

(54) LIQUID, HOMOGENOUS HERBICIDE COMPOSITION, A METHOD OF WEED CONTROL, A METHOD OF PRODUCTION OF LIQUID, HOMOGENOUS HERBICIDE COMPOSITION AND USE OF A LIQUID, HOMOGENOUS HERBICIDE COMPOSITION FOR WEED CONTROL

(75) Inventor: Woznica Zenon, Poznan (PL)

(73) Assignee: SN BIOTECH TECHNOLOGIES SP. Z O.O. SP. K., Poznan (PL)

(21) Appl. No.: 12/995,171

(22) PCT Filed: Nov. 6, 2008
(86) PCT No.: PCT/PL08/00079

§ 371 Date: Jan. 25, 2011

(51) Int. Cl. A01N 57/20; A01P 13/00

(52) U.S. Cl. 504/127; 504/206

(57) ABSTRACT

This invention relates to a liquid, homogenous herbicide composition, a method of weed control, a method of production of a liquid, homogenous herbicide composition and use of a liquid, homogenous herbicide composition for weed control. More precisely the invention relates to a liquid, homogenous herbicide composition containing glyphosate as the active substance and a mixture of modifying-activating adjuvants, made up of ammonium sulphate, one or several carboxylic acids, a non-ionic surfactant from the alkylpolyglycoside group of alkyl chain length Cg to C16 or its mixture with one or several amphoteric surfactants from the iminodipropionates, betaine and amino-oxide group, and compatibilising substances allowing preparation of a homogenous and stable formulation. The herbicide composition, after dilution with water and applied at an appropriate rate per area unit, is assigned for weed and other undesired plants control. Adjuvants contained in the composition exhibit multifunctional action: they overcoming the antagonistic effect of mineral salts found in water used for dilution and application of the herbicide, facilitating spray droplets retention and wetting of the surface of sprayed plants, intensify absorption of the herbicide active ingredient into plant cells and its transport to the site of action, ensuring as the result high and stable efficacy of glyphosate used in the composition in different technical and environmental conditions.

This invention relates to a liquid, homogenous herbicide composition, a method of weed control, a method of production of a liquid, homogenous herbicide composition and use of a liquid, homogenous herbicide composition for weed control. In more detail the invention relates to the liquid, concentrated herbicide composition containing glyphosate as an active ingredient and a mixture of modifying-activating adjuvants with multifunctional action, overcoming the antagonistic effect of mineral salts found in water used for dilution and application of the herbicide, as well as facilitating retention of spray droplets and wetting of the surface of sprayed plants, intensifying absorption of the herbicide active ingredient into plant cells and its transport to the site of action, ensuring as the result high and stable efficacy of glyphosate used in the composition in various technical and environmental conditions.

Glyphosate [N-(phosphonomethyl)glycine] is one of the most frequently applied herbicides for non-selective control of weeds and unwanted plants in agriculture and in non-agricultural areas. In recent years glyphosate also has found wider application for selective weed control in cultivated plant species made resistant to this active substance by genetic modification (RoundupReady® species). Glyphosate is an organic acid, of very low solubility in water. Due to this fact, commercial usable formulations of this herbicide are prepared based on water-soluble glyphosate salts, of which the ispropylamine, ammonium and trimesium salts (in liquid formulations) and ammonium salts (in solid formulations) are most frequently found. Other water-soluble glyphosate salts have been elaborated, described amongst others in patents U.S. Pat. No. 4,405,531, U.S. Pat. No. 4,147,719, U.S. Pat. No. 4,431,594, U.S. Pat. No. 4,437,874, U.S. Pat. No. 5,710,104, WO 8704712, WO 8303608, DD218366, EP73574, EP115176, EP124351, EP 369076 and EP103055.

Glyphosate is a foliar applied herbicide of systemic action, i.e., after retention of spray droplets on epigeal parts of plants and absorption of the active ingredient into plant cells, it is transported in the plant system to the site of action and there causes the phytotoxic effect, leading as the result to dying of plants. Due to the presence of natural plant barriers—like: the hydrophobic surface of leaves (the cuticle) and the lipoprotein construction of cell membranes, only a small quantity of the applied herbicide retains on the plant surface and reaches the site of action. Stressful environment conditions, especially low soil moisture (soil draught) and low air temperature and humidity have a strong negative influence on the retention, absorption and transport of glyphosate, and as a result, decrease biological activity. Also some mineral salts found in water used for dilution of the herbicide and its application, especially calcium and magnesium salts (causing so called water hardness), sodium, iron, manganese and other metal salts may chemically react with glyphosate, or after precipitation on the leaf surface may physically limit absorption, and as the result decrease the herbicidal activity.

In order to achieve high level of weed control by glyphosate, an appropriately chosen, very specific adjuvant is required for tank-mixing. Adjuvants, showing high suitability for use with this herbicide, include some non-ionic, cationic and amphoteric surface-active substances (surfactants) of high hydrophilicity, as well as some mineral and organic compounds, as for example ammonium sulphate and citric acid.

Adjuvants are introduced directly into glyphosate formulations in the production process (so called “build-in adjuvants”), and also they may be supplemented as separate products into the sprayer tank by the spray operator during preparation of the spray solution.

According to patent description WO 2000032045 surfactants increase glyphosate activity as the result of decreasing the spray drop size produced during spraying and decreasing of the surface tension. The change of the spray drop properties facilitates their retention on the surface of treated plants, allows good contact and increases absorption of the active substance into plant cells by the cuticular, hydrophobic wax layer.

According to patent description U.S. Pat. No. 6,881,707, surfactants suitable for activation of glyphosate include amongst others quaternary ammonium salts, amine ethers, alkylpolyglycosides, oxylates of fatty acids, oxyethylated secondary and tertiary alcohols, organosilicone compounds, some glycerides, polyglycerol and its derivatives and other surfactants and their mixtures. In the solution described in patent U.S. Pat. No. 5,912,209 in liquid or solid glyphosate formulations other surfactants also may be used such as: alkylmonoglycosides, alkylpolyglycosides, alkylesters, sucroses, tertiary and quaternary ethoxylated and non-ethoxylated alkylamines, alkylamine oxides and alkylbetaines, while according to patent description U.S. Pat. No. 6,451,735 it is advantageous to add to a glyphosate potassium salt formulation a mixture of two surfactants, of which one is an alkylglycoside, the second is an oxyethylated alkylamine.

Surfactants mentioned in described inventions, especially oxyethylated fatty amines, which are most frequently introduced into commercial glyphosate formulations or added by the applicator to the spray solution as additional products, do not provide a high glyphosate efficacy in situations when “hard water”, rich in calcium and magnesium ions, is used. Similar effect occurs when water containing large quantities of other antagonistic salts, for example sodium and iron, is used for making a spray solution.

It is generally known that ammonium sulphate—a common mineral fertiliser, effectively overcomes the antagonistic effect of antagonistic metal cations in water, and its action is especially distinct, if it is simultaneously used with an appropriately chosen surfactant. However, preparation of the spray solution with addition of the fertiliser form of ammonium sulphate is inconvenient for the user, as it requires preliminary laborious dissolving of this compound in water, and next filtering of the obtained solution before pouring into the sprayer tank in order to separate the insoluble technical impurities. In order to avoid this inconvenience, a number of homogenous solutions, hence convenient adjuvant formulations has been developed, containing ammonium sulphate in a mixture with an appropriately chosen surfactant.

According to patent description U.S. Pat. No. 5,356,861 and its continuation RE36149, the adjuvant composition dedicated for application with herbicides containing glyphosate and added to the sprayer tank as a separate product, is composed of a non-ionic surfactant from the alkylpolysaccharide group, ammonium sulphate and water. In patent description U.S. Pat. No. 6,364,926 the adjuvant or fertiliser composition is composed of an ampholytic surfactant, various ammonium salts, a spray drift retardant and water. According to patent description U.S. Pat. No. 6,228,807 and U.S. Pat. No. 6,645,914 (WO 2003/092373) homogenous and stable adjuvant formulations containing ammonium sulphate also can be obtained by mixing this surfactant with amphoteric surfactants represented by amine oxides, betaines and iminodipropionates. Patent description PL 197529 also indicates the possibility of including a cationic surfactant—alkyldimethylpolyoxyethyleneammonium hydroxide and ammonium sulphate in a homogenous and stable formulation. In the description of Austrian patent application WO 0126463 adjuvant formulations have been presented being a mixture of amphoteric surfactants with phospholipids and the ammonium salt of an ethoxylated phosphate ester derivative, and also salts such as: ammonium sulphate, alkylammonium sulphate, potassium phosphate, tetrapotassium pyrophosphate, sodium trisulphate, sodium sulphate and ammonium bicarbonate.

From the point of view of herbicide users it would be most advantageous to use such a glyphosate formulation, which would have a “build-in” adjuvant or a complex of adjuvants that overcome different barriers limiting its action and neutralise the negative effect of disadvantageous technical and environmental conditions. Building-in of an effective adjuvant, strictly a mixture of adjuvants, into the herbicide formulation is thus justified, as it eliminates the necessity of their replenishing addition when preparing the spray solution.

Addition of a complex of different adjuvants, especially a mixture of surfactants and mineral salts directly into the glyphosate formulation is relatively simple only in the case of preparation of very rarely used solid formulations of this herbicide, in which possibility of chemical reactions between the included components is practically insignificant. In accordance with patent description U.S. Pat. No. 6,228,807 nonionic, anionic, cationic or amphoteric surfactants with mineral salts represented by ammonium sulphate, potassium sulphate, potassium chloride, sodium sulphate and urea in solid form can be introduced into the solid glyphosate formulation. Unfortunately, in the case of liquid formulations most preferably used in practice, it is considerably more difficult due to the possibility of loss of formulation stability, this being manifested by precipitation of ammonium sulphate and other components already in a short time after preparation. Nevertheless, patent description EP 0274369 indicates a possibility of obtaining a stable, liquid formulation of a glyphosate isopropylamine salt with ammonium sulphate, as a result of introduction into the mixture a surfactant from the group of quaternary ammonium salts. Unfortunately, quaternary ammonium salts, due to disadvantageous influence on the health of humans and on the environment, are not permitted for use with pesticides. According to patent description U.S. Pat. No. 6,432,878, a liquid and stable glyphosate formulation with a built-in multicomponent adjuvant can be obtained by adding into the herbicide salt (e.g., isopropylamine or potassium) a mixture of adjuvants made up of a cationic surfactant from the group of oxyethylated fatty amines, citric acid, glycerol, ethylene glycol and propylene glycol. Introduction of a small quantity of citric acid to the described glyphosate formulation radically decreases irritating properties of the cationic surfactant present there, without a negative effect on its effectiveness aiding the herbicide action of glyphosate, while addition of propylene glycol guarantees maintaining of a low formulation viscosity in a wide range of temperatures.

In the description of JP 2233229, a herbicide composition has been presented based on N-(phosphonomethyl)glycine and its application. The aim of the solution was obtaining of a liquid composition containing a specific N-(phosphonomethyl)glycine, as the active component of the herbicide, ammonium sulphate and a specific linear or cyclic surfactant with incorporated ethylene or propylene oxide, i.e., an oxyethylated or oxypropylated surfactant.

In spite of conducted work and research, liquid glyphosate compositions obtained up till now, containing a mixture of adjuvants, composed of a surfactant, ammonium sulphate and other components, cannot fully optimise biological action of glyphosate in extreme differentiated technical and environmental conditions occurring in practice. This results from the fact that choice of surfactants for these compositions is in the first order determined by their compatibility with glyphosate and other supporting components, especially inorganic substances, such as for example ammonium sulphate, and not necessarily by the optimum influence of these surfactants on herbicidal effectiveness of glyphosate. Also, some formulations obtained until now cannot be practically used, due to the hazard for the environment they create.

The aim of this invention is to develop a multicomponent herbicide composition containing glyphosate and other components, which would overcome the antagonistic interaction of mineral salts found in water used for dilution and application of herbicides, would facilitate retention of spray solution droplets, as well as wetting of the surface of sprayed plants and would intensify absorption of the active ingredient glyphosate to plant cells and its transport to the site of action, which as the result would ensure high and stable effectiveness of the herbicide in the composition according to the herbicide invention in different technical and environmental conditions.

Realisation of such a determined aim and solving of problems described in the state of technology, connected with the choice of surfactants and other auxiliary substances in herbicide compositions, whilst avoiding complications described above, have been achieved in this invention.

The subject matter of invention a liquid, homogenous herbicide composition, comprising at least one water-soluble glyphosate salt and a mixture of adjuvants including at least one surfactant, ammonium sulphate, at least one carboxylic acid and a mixture of compatibilising substances, characterised in that the water-soluble glyphosate salt is at least one readily water-soluble salt chosen from the isopropylamine, sodium, potassium, ammonium and/or the trimesium glyphosate salt and that it is contained in the range from 120 to 400 g/L of the glyphosate acid equivalent and that the mixture of adjuvants is made up of a) at least one non-ionic alkylpolyglycoside surfactant or a mixture of surfactants from this group with at least one amphoteric surfactant from the iminodipropionates, betaine and amino-oxide group, preferably alkylpolyglycoside surfactants of branched alkyl chains made up of 8 to 16 carbon atoms (C₈ to C₁₆) of formula:

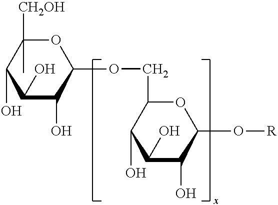

where:
R is a linear alkyl chain, including C₈ to C₁₆ alkyl chains;
x is an integer of values from 0 to 3,
b) ammonium sulphate is contained in the range from 20 to 240 g/L, c) at least one carboxylic acid, and/or mixture of carboxylic acids and/or salts of carboxylic acids contained in the composition in the range from 1 to 50 g/L, d) compatibilising substances, made up of triethanolamine and glycerol, in a ratio contained in the range from 0.8:1.2 to 1.2:0.8, and the total contents of these substances is from 50 to 200 g/L. Preferably, surfactants are alkylpolyglycoside surfactants with an alkyl chain of at least
   C₁₂, whilst the surfactant or their mixture contents in the herbicide composition is contained in the range from 5 to 150 g/L, preferably from 50 to 150 g/L.
   Preferably, the carboxylic acid is citric acid or an ammonium salt of the citric acid, contained in the range from 5 to 50 g/L.
   Preferably, compatibilising substances ensure stability of the mixture for a period of at least 180 days in the temperature range from 0 to 30° C.
   Preferably, glycerol additionally fulfils an adjuvant function, preferably a humectant limiting complete water evaporation from spray droplets and allowing more complete absorption of glyphosate into plant cells.
   Preferably, the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).
   Preferably, the glyphosate salt is additionally supplemented with antifoaming agents and/or anticorrosion agents and/or antifreezing agents and or agents counteracting drift of spray droplets and/or dyes and/or biostatic agents.

The next subject of this invention is a method of weed control based on using a spray solution containing a liquid, homogenous herbicide composition, containing at least one water-soluble glyphosate salt and a mixture of adjuvants including at least one surfactant, ammonium sulphate, at least one carboxylic acid and a mixture of compatibilising substances and water, characterised in that the glyphosate composition, containing at least one water-soluble glyphosate salt chosen from the isopropylamine, sodium, potassium, ammonium and/or the trimesium glyphosate salt, contained in the range from 120 to 400 g/L of the glyphosate acid equivalent and a mixture of adjuvants made up of a) at least one non-ionic alkylpolyglycoside surfactant or a mixture of surfactants from this group with at least one amphoteric surfactant from the iminodipropionates, betaine and amino-oxide group, preferably alkylpolyglycoside surfactants of branched alkyl chains made up of 8 to 16 carbon atoms (C₈ to C₁₆) of formula:

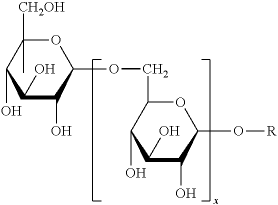

where:
R is a linear alkyl chain, including C₈ to C₁₆ alkyl chains;
x is an integer of values from 0 to 3,
b) ammonium sulphate is contained in the range from 20 to 240 g/L, c) at least one carboxylic acid and/or mixture of carboxylic acids and/or salts of carboxylic acids contained in the composition in the range from 1 to 50, d) compatibilising substances, made up of triethanolamine and glycerol, in a ratio contained in the range from 0.8:1.2 to 1.2:0.8, and the total contents of these substances is from 50 to 200 g/L, e) compatibilising substances, made up of triethanolamine and glycerol, in a ratio contained in the range from 0.8:1.2 to 1.2:0.8, where the total contents of these substances is from 50 to 200 g/L, are applied in the total volume of the spray solution at a concentration from 0.1 to 20% by volume.
   Preferably, surfactants are used being alkylpolyglycoside surfactants with an alkyl chain of at least C₁₂, whilst the surfactant or their mixture contents in the herbicide composition is contained in the range from 5 to 150 g/L, preferably from 50 to 150 g/L.
   Preferably, the preferred carboxylic acid is a citric acid or an ammonium salt of citric acid in a quantity of 5 to 50 g/L.
   Preferably, glycerol is applied fulfilling a humectant limiting complete water evaporation from spray droplets and ensuring by this more complete absorption of glyphosate into plant cells.
   Preferably, the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).
   Preferably, the glyphosate salt is additionally supplemented with antifoaming agents and/or anticorrosion agents and/or antifreezing agents and or agents counteracting spray drift and/or dyes and/or biostatic agents.

The next subject of invention is a method of production of a liquid, homogenous herbicide composition, containing at least one water-soluble glyphosate salt and a mixture of adjuvants including at least one surfactant, ammonium sulphate, at least one carboxylic acid and a mixture of compatibilising substances and water, characterised in that in step 1) an adjuvant mixture is prepared made of a) at least one non-ionic alkylpolyglycoside surfactant or a mixture of surfactants from this group with at least one amphoteric surfactant from the iminodipropionates, betaine and amino-oxide group, preferably alkylpolyglycoside surfactants of branched alkyl chains made up of 8 to 16 carbon atoms (C₈ to C₁₆) of formula:

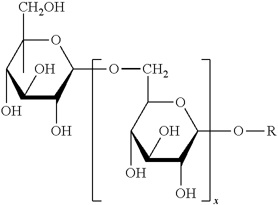

where:
R is a linear alkyl chain, including C₃ to C₁₆ alkyl chains;
x is an integer of values from 0 to 3,
b) ammonium sulphate is contained in the range from 20 to 240 g/L, c) at least one carboxylic acid and/or mixture of carboxylic acids, and/or salts of carboxylic acids contained in the composition in the range from 1 to 50 g/L, at contents of the carboxylic acid or their mixture or salt in the composition from 1 to 50 g/L, d) compatibilising substances, allowing stable blending of all components with glyphosate, made up of triethanolamine and glycerol, in a ratio contained in the range from 0.8:1.2 to 1.2:0.8, where the total contents of these substances in the composition is from 50 to 200 g/L, after which in step 2) a composition is prepared by adding to a water-soluble glyphosate salt making up at least one water-soluble salt chosen from the isopropylamine, sodium, potassium, ammonium and/or trimesium salt of glyphosate contained in the range from 120 to 400 g/L of the glyphosate acid equivalent, a mixture prepared in step 1 of the adjuvant with substances allowing blending of all components in a homogenous and stable composition.
   Preferably, the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).
   Preferably, the glyphosate salt is additionally supplemented with antifoaming agents and/or anticorrosion agents and/or antifreezing agents and or agents counteracting drift of spray droplets and/or dyes and/or biostatic agents.

The next subject of invention is use of a liquid, homogenous herbicide composition, containing at least one water-soluble glyphosate salt and a mixture of adjuvants including at least one surfactant, ammonium sulphate, at least one carboxylic acid and a mixture of compatibilising substances, characterised in that the water-soluble glyphosate salt is at least one readily water-soluble salt chosen from the isopropylamine, sodium, potassium, ammonium and/or the trimesium glyphosate salt and that it is contained in the range from 120 to 400 g/L of the glyphosate acid equivalent and that the mixture of adjuvants is made up of a) at least one non-ionic alkylpolyglycoside surfactant or a mixture of surfactants from this group with at least one amphoteric surfactant from the iminedipropionic, betaine and amino-oxide group, preferably alkylpolyglycoside surfactants of branched alkyl chains made up of 8 to 16 carbon atoms (C₈ to C₁₆) of formula:

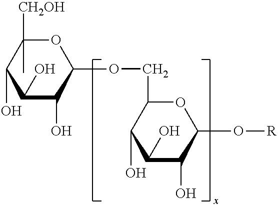

where:
R is a linear alkyl chain, including C₈ to C₁₆ alkyl chains;
x is an integer of values from 0 to 3,
b) ammonium sulphate is contained in the range from 20 to 240 g/L, c) at least one carboxylic acid and/or mixture of carboxylic acids, at contents of the carboxylic acid or their mixture or their salts in the composition from 1 to 50 g/L, d) compatibilising substances, made up of triethanolamine and glycerol, in a ratio contained in the range from 0.8:1.2 to 1.2:0.8, and the total contents of these substances are from 50 to 200 g/L, for weed control.
   Preferably, surfactants are used being alkylpolyglycoside surfactants with an alkyl chain of at least C₁₂, whilst the surfactant or their mixture contents in the herbicide composition is contained in the range from 5 to 150 g/L, preferably from 50 to 150 g/L.
   Preferably, the carboxylic acid is citric acid or an ammonium salt of citric acid, contained in the range from 5 to 50 g/L.
   Preferably, glycerol is applied fulfilling a humectant function limiting complete water evaporation from spray droplets, ensuring complete absorption of glyphosate into plant cells. Preferably, the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).
   Preferably, the glyphosate salt is additionally supplemented with antifoaming agents and/or anticorrosion agents and/or antifreezing agents and or agents counteracting drift of spray droplets and/or dyes and/or biostatic agents.

Substances allowing blending of all components in a homogenous and stable composition, namely triethanolamine and glycerol, are an extremely significant part of the glyphosate composition being the subject of the invention. It was unexpectedly found that these components added to the formulation in quantities from 20 to 75 g/L each and in a 1:1 ratio, allow obtaining of a homogenous mixture, which is stable for a period of at least 180 days in the 0 to 30° C. temperature range. Glycerol in the formulation additionally fulfils the function of adjuvant, more strictly a humectant—a substance limiting complete evaporation of water from spray droplets and allowing due to this more complete absorption of glyphosate into plant cells.

The composition being the subject of the invention can be prepared by mixing all components in determined quantities in a mechanical or hydraulic mixer. It is more advantageous to use an appropriate quantity of one glyphosate salt (the quantity of salt will depend on the intended contents of the acid glyphosate equivalent in the formulation), and next addition to the mixer of an earlier prepared mixture of adjuvants to a determined volume and mixing to the moment of obtaining a homogenous composition.

The herbicide composition, the object of the invention, is assigned for weed control in agriculture and in non-agricultural areas after dilution with water and preparation of the spray solution with all types of sprayers and applicators. In the case of hydraulic sprayers, the formulation in the required rate is added to a determined quantity of water, depending on the sprayer spray volume. The quantity of the spray solution in which the herbicide formulation constitutes usually from 1 to 10%, varies in practical conditions from 50 to 400 L/ha.

The invention is presented in examples below, which however do not exhaust all possible methods of preparation and application.

### EXAMPLE 1

In the example the preparation method has been given of a herbicide composition containing 240 g/L of the acid glyphosate equivalent and a mixture of adjuvants by a two-step method.

a) step 1—preparation of a mixture of adjuvants with substances allowing stable blending of all components with glyphosate.

The following have been added to a 1 litre Erlenmeyer flask:
1.500 g (50% by weight) of ammonium sulphate in the form of a 40% aqueous solution,
2.40 g (4% by weight) of citric acid,
3.206 g (20.6% by weight) of a non-ionic surfactant from the group of alkylopolyglycosides (commercial product GLUCOPON 650 EC from Cognis Co. being a 50% aqueous solution of the alkylopolyglycoside surfactant),
4.120 g (12% by weight) of triethanolamine,
5.130 g (13% by weight) of glycerol,
6.4 g (0.4% by weight) of an antifoaming agent (STRUKTOL SB 2032 product from ICSO Chemical Production Spólka z o.o.)
   All were mixed with a magnetic stirrer at a temperature of approx. 20° C. for about 10 minutes until complete homogenization had been reached. A clear, straw-yellow solution has been obtained, containing 20% by weight of pure ammonium sulphate, 4% by weight of citric acid, 10.3% by weight of pure non-ionic surfactant from the group of alkylpolyglycosides, 12% by weight of triethanolamine, 13% by weight of glycerol, 0.4% by weight of antifoaming agent and 40.3% by weight of water. The density of such prepared mixture was equal to 1.20 g/cm³, while the pH of 5.5.
   b) step 2—preparation of the final composition.

To a 1 litre Erlenmeyer flask were added 516 g of 62% glyphosate isopropylamine salt, and next 696.4 g (to a volume of 1 litre) of the adjuvant mixture prepared in step 1 with substances allowing blending of all components into a homogenous and stable formulation. All were mixed with a magnetic stirrer to the moment of obtaining a homogenous straw-yellow solution. In one litre of such a prepared herbicide composition the following were present: 516 g of 62% isopropylamine salt of glyphosate (corresponding to 240 g of acid equivalent), 138.9 g of ammonium sulphate, 27.8 g of citric acid, 71.5 g of pure non-ionic surfactant from the group of alkylopolyglycosides, 83.3 g of triethanolamine, 90.3 g of glycerol, 2.8 g of antifoaming agent. Water formed the remaining part of the formulation. The formulation density was equal to 1.21 g/cm³, and the pH 4.7.

### EXAMPLE 2

The composition obtained in example 1, designated as EXPH-1 240 SL (of 240 g/L contents of glyphosate acid equivalent) and formulation EXPH-2 180 SL obtained in a similar way as in example 1 (of 180 g/L contents of glyphosate acid equivalent) were tested at different rates in a field experiment in order to determine the herbicidal effectiveness against couch grass [Elymus repens (L.) Gould]. The experiment was performed in a non-agricultural area, uniformly infested with couch grass (120-180 sprouts per 1 m²). Herbicides EXPH-1 240 SL and EXPH-2 180 SL were applied at rates 360, 720 and 1080 g/ha (according to the acid equivalent) with water of 22 German degrees of total hardness. For comparison two reference preparations have been applied in the same rates according to the glyphosate acid equivalent—Roundup 360 SL and Roundup Energy 450 SL—preparations from Monsanto Co. Spraying treatment was performed at the 4-8 leaf couch grass stage, with a hydraulic boom sprayer from R&D, equipped with 4 TeeJet-11002VP nozzles, ensuring spray volume of 170 l/ha. The experiment was conducted using a randomised complete block design with four replicates—and the area of an individual plot was equal to 20 m². Visual assessment of the herbicidal effectiveness in relation to couch grass was performed 2, 4 and 8 weeks after treatment. Results presented in table 1 indicate that EXPH-1 240 SL, and especially EXPH-2 180 SL, have shown greater herbicidal effectiveness than the comparative reference herbicides containing glyphosate, especially when they had been applied in lower rates.

TABLE 1
Efficacy of herbicides containing glyphosate in relation to couch
grass (Elymus repens)

| | | Weeks after | | |
|---|---|---|---|---|
| | | treatment* | | |
| | | 2 | 4 | 8 |
| | Glyphosate rate | couch grass | | |
| Herbicide | [g ai/ha] | control [%] | | |
| Roundup 360 SL | 360 | 20 | 39 | 42 |
| Roundup Energy 450 SL | 360 | 20 | 35 | 40 |
| EXPH-1 240 SL | 360 | 23 | 45 | 48 |
| EXPH-2 180 SL | 360 | 28 | 58 | 55 |
| Roundup 360 SL | 720 | 40 | 63 | 71 |
| Roundup Energy 450 SL | 720 | 40 | 60 | 70 |
| EXPH-1 240 SL | 720 | 75 | 95 | 98 |
| EXPH-2 180 SL | 720 | 80 | 96 | 99 |
| Roundup 360 SL | 1080 | 80 | 90 | 92 |
| Roundup Energy 450 SL | 1080 | 78 | 90 | 90 |
| EXPH-1 240 SL | 1080 | 92 | 99 | 99 |
| EXPH-2 180 SL | 1080 | 90 | 99 | 99 |
| NIR(0.05) | | 7 | 9 | 5 |

*spraying treatment was performed on Nov. 08, 2008

1. A liquid, homogenous herbicide composition, containing at least one water-soluble glyphosate salt and a mixture of adjuvants including at least one surfactant, ammonium sulphate, at least one carboxylic acid and a mixture of compatibilising substances, characterised in that the water-soluble glyphosate salt is at least one readily water-soluble salt chosen from the isopropylamine, sodium, potassium, ammonium and/or the trimesium glyphosate salt and that it is contained in the range from 120 to 400 g/L of the glyphosate acid equivalent and that the mixture of adjuvants is made up of a) at least one non-ionic alkylpolyglycoside surfactant or a mixture of surfactants from this group with at least one amphoteric surfactant from the iminodipropionates, betaine and amino-oxide group, preferably alkylpolyglycoside surfactants of branched alkyl chains made up of 8 to 16 carbon atoms (C₈ to C₁₆) of formula: 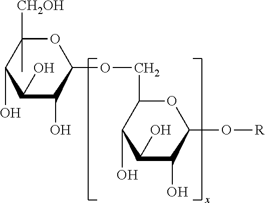
where:
R is a linear alkyl chain, including C₈ to C₁₆ alkyl chains;
x is an integer of values from 0 to 3,
b) ammonium sulphate is contained in the range from 20 to 240, c) at least one carboxylic acid, and/or mixture of carboxylic acids and/or salts of carboxylic acids contained in the composition in the range from 1 to 50 g/L, d) compatibilising substances, made up of triethanolamine and glycerol, in a ratio contained in the range from 0.8:1.2 to 1.2:0.8, and the total contents of these substances is from 50 to 200 g/L.

2. The composition according to claim 1, characterised in that surfactants are alkylpolyglycoside surfactants with an alkyl chain of at least C₁₂, whilst the surfactant or their mixture contents in the herbicide composition is contained in the range from 5 to 150 g/L, preferably from 50 to 150 g/L.

3. The composition according to claim 1, characterised in that the carboxylic acid is citric acid or an ammonium salt of the citric acid, contained in the range from 5 to 50 g/L.

4. The composition according to claim 1, characterised in that compatibilising substances ensure stability of the mixture for a period of at least 180 days in the temperature range from 0 to 30° C.

5. The composition according to claim 1, characterised in that glycerol additionally fulfils an adjuvant function, preferably a humectant limiting complete water evaporation from spray droplets and allowing more complete absorption of glyphosate into plant cells.

6. The composition according to claim 1, characterised in that the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).

7. The composition according to claim 1, characterised in that the glyphosate salt is additionally supplemented with antifoaming agents and/or anticorrosion agents and/or antifreezing agents and or agents counteracting drift of spray droplets and/or dyes and/or biostatic agents.

8. A method of weed control based on using a spray solution containing a liquid, homogenous herbicide composition, containing at least one water-soluble glyphosate salt and a mixture of adjuvants including at least one surfactant, ammonium sulphate, at least one carboxylic acid and a mixture of compatibilising substances and water, characterised in that the glyphosate composition, containing at least one water-soluble glyphosate salt chosen from the isopropylamine, sodium, potassium, ammonium and/or the trimesium glyphosate salt, contained in the range from 120 to 400 g/L of the glyphosate acid equivalent and a mixture of adjuvants made up of a) at least one non-ionic alkylpolyglycoside surfactant or a mixture of surfactants from this group with at least one amphoteric surfactant from the iminodipropionates, betaine and amino-oxide group, preferably alkylpolyglycoside surfactants of branched alkyl chains made up of 8 to 16 carbon atoms (C₈ to C₁₆) of formula: 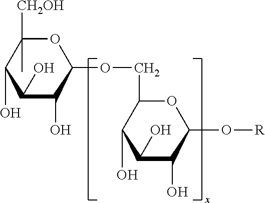
where:
R is a linear alkyl chain, including C₈ to C₁₆ alkyl chains;
x is an integer of values from 0 to 3,
b) ammonium sulphate is contained in the range from 20 to 240 g/L, c) at least one carboxylic acid and/or mixture of carboxylic acids and/or salts of carboxylic acids contained in the composition in the range from 1 to 50 g/L, d) compatibilising substances, made up of triethanolamine and glycerol, in a ratio contained in the range from 0.8:1.2 to 1.2:0.8, and the total contents of these substances is from 50 to 200 g/L,
e) compatibilising substances, made up of triethanolamine and glycerol, in a ratio contained in the range from 0.8:1.2 to 1.2:0.8, where the total contents of these substances is from 50 to 200 g/L, are applied in the total volume of the spray solution at a concentration from 0.1 to 20% by volume.

9. The method according to claim 8, characterised in that surfactants are used being alkylpolyglycoside surfactants with an alkyl chain of at least C₁₂, whilst the surfactant or their mixture contents in the herbicide composition is contained in the range from 5 to 150 g/L, preferably from 50 to 150 g/L.

10. The method according to claim 8, characterised in that the preferred carboxylic acid is citric acid or an ammonium salt of citric acid in a quantity of 5 to 50 g/L.

11. The method according to claim 8, characterised in that glycerol is applied fulfilling a humectant limiting complete water evaporation from spray droplets and ensuring by this more complete absorption of glyphosate into plant cells.

12. The method according to claim 8, characterised in that the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).

13. The method according to claim 8, characterised in that the glyphosate salt is additionally supplemented with antifoaming agents and/or anticorrosion agents and/or antifreezing agents and or agents counteracting drift of spray droplets and/or dyes and/or biostatic agents.

14. A method of production of a liquid, homogenous herbicide composition, containing at least one water-soluble glyphosate salt and a mixture of adjuvants including at least one surfactant, ammonium sulphate, at least one carboxylic acid and a mixture of compatibilising substances and water, characterised in that in step 1) an adjuvant mixture is prepared made of a) at least one non-ionic alkylpolyglycoside surfactant or a mixture of surfactants from this group with at least one amphoteric surfactant from the iminodipropionates, betaine and amino-oxide group, preferably alkylpolyglycoside surfactants of branched alkyl chains made up of 8 to 16 carbon atoms (C₈ to C₁₆) of formula: 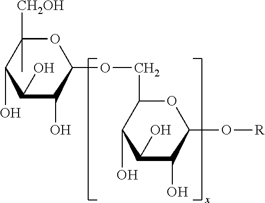
where:
R is a linear alkyl chain, including C₈ to C₁₆ alkyl chains;
x is an integer of values from 0 to 3,
b) ammonium sulphate is contained in the range from 20 to 240 g/L, c) at least one carboxylic acid and/or mixture of carboxylic acids, and/or salts of carboxylic acids contained in the composition in the range from 1 to 50 g/L, at contents of the carboxylic acid or their mixture or salt in the composition from 1 to 50 g/L, d) compatibilising substances, allowing stable blending of all components with glyphosate, made up of triethanolamine and glycerol, in a ratio contained in the range from 0.8:1.2 to 1.2:0.8, where the total contents of these substances in the composition is from 50 to 200 g/L, after which in step 2) a composition is prepared by adding to a water-soluble glyphosate salt making up at least one water-soluble salt chosen from the isopropylamine, sodium, potassium, ammonium and/or trimesium salt of glyphosate contained in the range from 120 to 400 g/L of the glyphosate acid equivalent, a mixture prepared in step 1 of the adjuvant with substances allowing blending of all components in a homogenous and stable composition.

15. The method according to claim 14, characterised in that the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).

16. The method according to claim 14, characterised in that the glyphosate salt is additionally supplemented with antifoaming agents and/or anticorrosion agents and/or antifreezing agents and or agents counteracting drift of spray droplets and/or dyes and/or biostatic agents.

17. Use of a liquid, homogenous herbicide composition, containing at least one water-soluble glyphosate salt and a mixture of adjuvants including at least one surfactant, ammonium sulphate, at least one carboxylic acid and a mixture of compatibilising substances, wherein the water-soluble glyphosate salt is at least one readily water-soluble salt chosen from the isopropylamine, sodium, potassium, ammonium and/or the trimesium glyphosate salt and that it is contained in the range from 120 to 400 g/L of the glyphosate acid equivalent and that the mixture of adjuvants is made up of a) at least one non-ionic alkylpolyglycoside surfactant or a mixture of surfactants from this group with at least one amphoteric surfactant from the iminedipropionic, betaine and amino-oxide group, preferably alkylpolyglycoside surfactants of branched alkyl chains made up of 8 to 16 carbon atoms (C₈ to C₁₆) of formula: 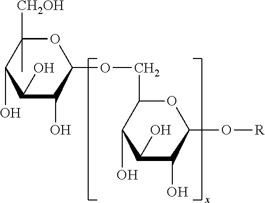
where:
R is a linear alkyl chain, including C₈ to C₁₆ alkyl chains;
x is an integer of values from 0 to 3,
b) ammonium sulphate is contained in the range from 20 to 240 g/L, c) at least one carboxylic acid and/or mixture of carboxylic acids, at contents of the carboxylic acid or their mixture or their salts in the composition from 1 to 50 g/L, d) compatibilising substances, made up of triethanolamine and glycerol, in a ratio contained in the range from 0.8:1.2 to 1.2:0.8, and the total contents of these substances are from 50 to 200 g/L, for weed control.

18. Use according to claim 17, wherein surfactants being alkylpolyglycoside surfactants with an alkyl chain of at least C₁₂, whilst the surfactant or their mixture contents in the herbicide composition is contained in the range from 5 to 150 g/L, preferably from 50 to 150 g/L are used.

19. Use according to claim 17, wherein the carboxylic acid is citric acid or an ammonium salt of citric acid, contained in the range from 5 to 50 g/L.

20. Use according to claim 17, wherein glycerol is applied fulfilling a humectant function limiting complete water evaporation from spray droplets, ensuring complete absorption of glyphosate into plant cells.

21. Use according to claim 17, wherein the glyphosate salt is additionally supplemented with a water-soluble salt of 2,4-D (2,4-dichlorophenoxyacetic acid) and/or MCPA (4-chloro-2-methylphenxoyacetic acid) and/or dicamba (3,6-dichloro-o-anisic acid).

22. Use according to claim 17, wherein the glyphosate salt is additionally supplemented with antifoaming agents and/or anticorrosion agents and/or antifreezing agents and or agents counteracting drift of spray droplets and/or dyes and/or biostatic agents.
